(19) United States
(12) Patent Application Publication
(10) Pub. No.: US 2026/0074757 A1
(43) Pub. Date: Mar. 12, 2026

(54) CODEBOOK DESIGN FOR CSI ENHANCEMENT TO EXPLOIT TIME DOMAIN PROPERTIES

(71) Applicant: APPLE INC., Cupertino, CA (US)

(72) Inventors: Haitong Sun, Cupertino, CA (US); Ismael Gutierrez Gonzalez, San Jose, CA (US); Weidong Yang, San Diego, CA (US); Dawei Zhang, Saratoga, CA (US); Wei Zeng, San Diego, CA (US); Louay Jalloul, San Jose, CA (US); Chunxuan Ye, San Diego, CA (US); Huaning Niu, San Jose, CA (US)

(21) Appl. No.: 19/102,191

(22) PCT Filed: Aug. 10, 2023
(86) PCT No.: PCT/US2023/071972

§ 371 Date: Feb. 7, 2025

Related U.S. Application Data
(60) Provisional application No. 63/371,090, filed on Aug. 11, 2022.

(51) Int. Cl. H04B 7/06; H04W 72/0446

(52) U.S. Cl. CPC H04B 7/0626; H04B 7/0639; H04W 72/0446

(57) ABSTRACT

Apparatus and methods are provided for codebook configuration including enhancements for channel time domain properties. A user equipment (UE) receives a channel measurement resource (CMR) configuration to support channel state information (CSI) reporting based on channel time domain properties. The CMR configuration corresponds to a burst of N time domain equally spaced CMR. The UE measures, based on the CMR configuration, CSI references signals (CSI-RSs) from one or more transmission and reception point (TRP). The UE determines, based on measurements of the CSI-RSs, multiple time domain equally spaced precoding matrix indicator (PMI) matrices. The UE encodes the multiple time domain equally spaced PMI matrices using N orthogonal discrete Fourier transform (DFT) sequences as time or Doppler domain basis, where each of the N orthogonal DFT sequences includes N entries. The UE reports the multiple time domain equally spaced PMI matrices that are encoded using time or Doppler domain basis.

### CROSS-REFERENCE TO RELATED APPLICATION(S)

This application claims the benefit of U.S. Provisional Patent Application No. 63/371,090, filed Aug. 11, 2022, which is hereby incorporated by reference herein in its entirety.

### TECHNICAL FIELD

This application relates generally to wireless communication systems, including codebook configuration.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a PMI matrix (codebook) used in certain embodiments herein.

FIG. 2 illustrates multi-TRP operation that may be used according to certain embodiments disclosed herein.

FIG. 3 illustrates a burst of CSI-RS for CMR obtained through the use of a DFT sequence according to embodiments disclosed herein.

FIG. 4 illustrates a flowchart of a method for a UE for communication in a wireless network, according to embodiments herein.

FIG. 5 illustrates a flowchart of a method for a wireless network, according to embodiments herein.

FIG. 6 illustrates an example architecture of a wireless communication system, according to embodiments disclosed herein.

FIG. 7 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Many wireless communication standards provide for the use of known signals (e.g., pilot or reference signals) for a variety of purposes, such as synchronization, measurements, equalization, control, etc. For example, in cellular wireless communications, a reference signals (RS) may be provided to deliver a reference point for downlink power. When a wireless communication device or mobile device (i.e., UE) attempts to determine downlink power (e.g., the power of the signal from a base station, such as eNB for LTE and gNB for NR), it measures the power of the reference signal and uses it to determine the downlink cell power. The reference signal also assists the receiver in demodulating the received signals. Since the reference signals include data known to both the transmitter and the receiver, the receiver may use the reference signal to determine/identify various characteristics of the communication channel. This is commonly referred to as channel estimation, which is used in many high-end wireless communications such as LTE and 5G-NR communications. Known channel properties of a communication link in wireless communications are referred to as channel state information (CSI), which provides information indicative of the combined effects of, for example, scattering, fading, and power decay with distance. The CSI makes it possible to adapt transmissions to current channel conditions, which is useful for achieving reliable communications with high data rates in multi-antenna systems.

Oftentimes multi-antenna systems use precoding for improved communications. Precoding is an extension of beamforming to support multi-stream (or multi-layer) transmissions for multi-antenna wireless communications and is used to control the differences in signal properties between the respective signals transmitted from multiple antennas by modifying the signal transmitted from each antenna according to a precoding matrix. In one sense, precoding may be considered a process of cross coupling the signals before transmission (in closed loop operation) to equalize the demodulated performance of the layers. The precoding matrix is generally selected from a codebook that defines multiple precoding matrix candidates, wherein a precoding matrix candidate is typically selected according to a desired performance level based on any of a number of different factors such as current system configuration, communication environment, and/or feedback information from the receiver (e.g., UE) receiving the transmitted signal(s).

The feedback information is used in selecting a precoding matrix candidate by defining the same codebook at both the transmitter and the receiver, and using the feedback information from the receiver as an indication of a possibly preferred precoding matrix. In such cases the feedback information includes what is referred to as a precoding matrix index (PMI), which can be based on properties of the signals received at the receiver. For example, the receiver may determine that a received signal has relatively low signal-to-noise ratio (SNR), and may accordingly transmit a PMI that would replace a current precoding matrix with a new precoding matrix to increase the signal-to-noise ratio (SNR).

In 3GPP NR systems, two types of codebook, Type I codebook and Type II codebook, have been standardized for CSI feedback in support of advanced MIMO operations. The two types of codebook are constructed from a two-dimensional (2D) discrete Fourier transform (DFT) based grid of beams, enabling CSI feedback of beam selection and phase shift keying (PSK) based co-phase combining between two polarizations. Type II codebook based CSI feedback also reports the wideband and subband amplitude information of the selected beams, allowing for more accurate CSI to be obtained. This, in turn, provides improved precoded MIMO transmissions over the network.

Under certain circumstances, the set of precoding matrix candidates that can be selected from the codebook may need to be limited. For example, the network may prevent the receiver from selecting some precoding matrix candidates while allowing it to select others. This is commonly referred to as codebook subset restriction (CBSR). CBSR may include the transmission of a CBSR bitmap from a transmitter (e.g., base station) to a receiver (e.g., UE). The CBSR bitmap typically includes a bit corresponding to each precoding matrix in the codebook, with the value of each bit (e.g., “0” or “1”) indicating to the receiver whether or not the receiver is restricted from considering a corresponding precoding matrix candidate as a possibly preferred precoding candidate to request from the base station. One disadvantage of CBSR is increased signaling overhead. For example, in some systems, the CBSR bitmap might contain a high number (e.g. 64) of bits per channel, requiring a transmitting device to transmit a relatively large amount of information to implement CBSR for all of its channels.

For multi-user multiple-in multiple-out (MIMO) systems, a base station may configure multiple UEs (e.g. two UEs) to report their precoding matrices, or precoding matrix candidates in mutually orthogonal directions. To reduce the CSI computation complexity for the UE, a base station may remove from consideration, based on uplink measurements, certain unlikely beams, thereby allowing the UE to not test the precoders formed by those beams that were removed from consideration. In other words, in order to reduce computation complexity, based on UL measurements the base station can restrict the UE to narrow the search space. Thus, the UE does not have to consider the entire codebook.

For 3GPP Release-15 (Rel-15) Type II port selection codebook, a beam-formed channel state information reference signal (CSI-RS) exploits downlink (DL) and uplink (UL) channel reciprocity. For example, the base station estimates the UL channel and, based on channel reciprocity, acquires the channel state information regarding the DL channel. Then, based on the DL channel information, the base station precodes different ports in CSI-RS differently for the UE to perform further CSI reporting for CSI refinement. The UE measures CSI-RS and provides feedback to the base station. For a total number X of CSI-RS ports, X/2 ports are horizontally polarized (H-pol) and X/2 ports are vertically polarized (V-pol). L CSI-RS ports are selected out of X/2 CSI-RS ports. The first CSI-RS port may be selected every d ports (e.g., d is either 1 or 2 or 3 or 4). Then, consecutive L (e.g., 1, 2, 4) ports are selected with wrap around.

3GPP Rel-16 Type II port selection codebook enhancement uses the same port selection design as 3GPP Rel-15. When subband PMI is configured, a frequency domain DFT matrix can be used to compress the linear combination coefficients.

For Type II port selection codebook, it may be assumed that the base station will precode the CSI-RS based on channel reciprocity (i.e., DL channel estimated based on UL channel). For frequency division duplexing (FDD), exact channel reciprocity may not exist, especially when the duplexing distance is large. However, even for FDD, partial reciprocity may still exist when, for example, the angle of arrival or departure is similar between DL and UL carriers and/or the channel delay profile is similar between DL and UL carriers.

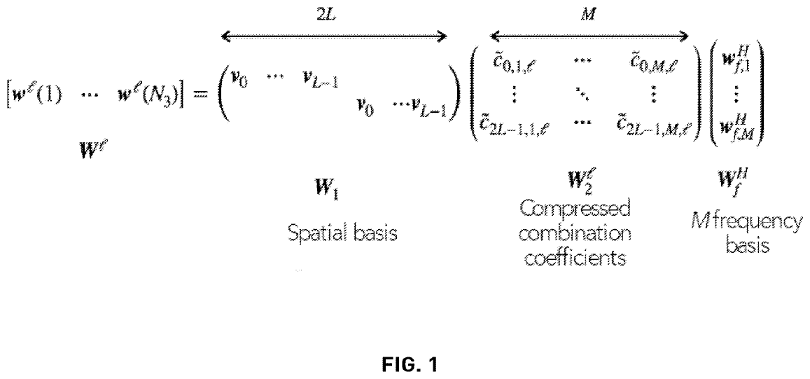

FIG. 1 illustrates a PMI matrix (codebook) used in certain embodiments herein. In the illustrated example, a Type II port selection codebook structure is given by

$${W}^{ℓ} = {W}_{1} * {W}_{2}^{ℓ} * {W}_{f}^{H}$$

(also notated for simplicity herein as W=W₁*W₂*W_{f} or W=W1W2Wf), where W is the PMI matrix (also referred to herein simply as codebook), W₁ is a spatial basis selection matrix (also referred to herein as a port selection matrix W₁), W₂ provides compressed combination coefficients, W_{f} is a frequency basis selection matrix, l is a layer index, N₃ is the number of PMI subbands in frequency (i.e., the length or number of entries in each frequency base), L is the number of selected spatial basis (i.e., number of selected ports), M is the number of selected frequency basis, and H denotes a Hermitian matrix or conjugate transpose operation. For simplicity. “W_{f}” or “Wf” assumes that the Hermitian operation has already been performed. These and other parameters of

$${W}^{ℓ} = {W}_{1} * {W}_{2}^{ℓ} * {W}_{f}^{H}$$

are shown in other figures and/or described in detail below.

In certain systems, for port selection codebook enhancements utilizing DL/UL reciprocity of angle and/or delay, support is provided for codebook structure W=W₁*W₂*W_{f} where the port selection matrix W₁ is a free selection matrix, with the identity matrix as a special configuration. The frequency basis selection matrix W_{f} is a DFT based compression matrix in which N₃=N_{CQISubband}*R and Mv>=1, where R is a size of the channel quality indicator (CQI) subband divided by the size of the PMI subband, and My is the number of selected frequency basis. N₃ is the number of PMI subbands for frequency basis selection. At least one value of Mv>1 may be supported. In certain such systems, value(s) of My may be decided (e.g., Mv=2). In other embodiments, support of Mv>1 is a UE optional feature, taking into account UE complexity related to codebook parameters. However, candidate value(s) of R, mechanisms for configuring/indicating to the UE and/or mechanisms for selecting/reporting by UE for W_{f} have yet to be determined. In addition, or in other systems, W_{f} can be turned off by the base station. When turned off, W_{f} may be an all-one vector.

In Rel-15, Type II and Type II port selection codebook is specified based on W₁*W₂. In Rel-16, enhanced Type II and Type II port selection codebook is specified based on W₁*W₂*W_{f}.

In Rel-17, further enhanced Type II port selection codebook is specified. For example, CSI feedback in Rel-17 is further enhanced for non-coherent joint transmission (NCJT) for multiple transmission and reception point (TRP) operation (referred to as multi-TRP or mTRP). In certain wireless networks, NCJTs may be used to provide multiple-input multiple-output (MIMO), multiple-user (MU) MIMO, and/or coordinated multi-point (CoMP) communications. The NCJTs may be from multi-TRP, multiple panels (multi-panels) of a TRP, or a combination thereof. Coherent joint transmission (CJT) uses synchronization among TRPs. However, for distributed TRPs, the precoders may not be jointly designed and such that the TRPs are not synchronized. Instead, each TRP derives the precoder independently without knowledge of the precoders used by the other TRPs. Thus, the joint transmission is non-coherent. In Rel-17, CSI feedback for NCJT for multi-TRPs is based on Type I MIMO codebook, which may support single downlink control information (DCI) multi-TRP NCJT scheme 1a (i.e., spatial domain multiplexing (SDM)).

In certain communication systems (e.g., Rel-18 NR), it may be desirable to provide CSI enhancement to support CJT for multi-TRP. CJT assumes that multiple TRPs can jointly precode the transmission in a coherent way. Certain such systems may, for example, target frequency range 1 (FR1) and up to four TRPs, assuming an ideal backhaul and synchronization as well as the same number of antenna ports across TRPs, as follows: Rel-16/17 Type II codebook refinement for CJT mTRP targeting FDD and its associated CSI reporting, taking into account throughput-overhead tradeoff. However, embodiments disclosed herein are not so limited (fewer than four or more than four TRPs may be used).

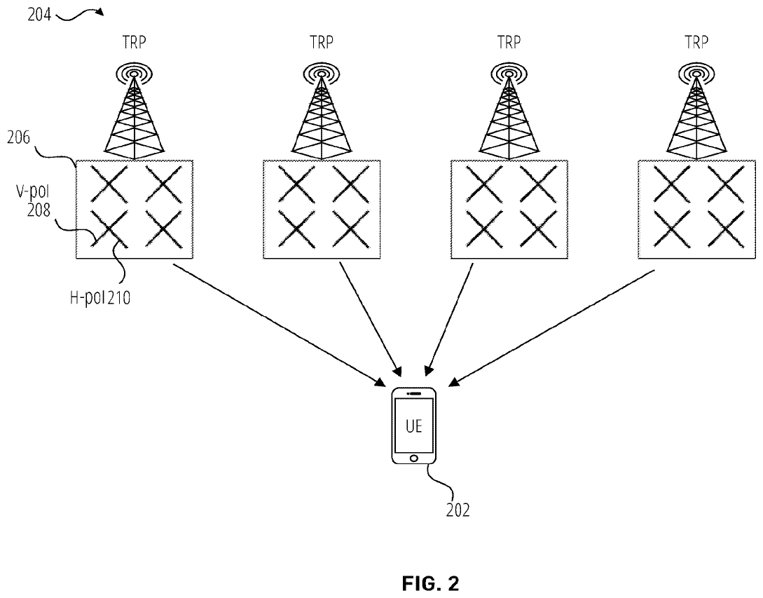

For example, FIG. 2 illustrates multi-TRP operation that may be used according to certain embodiments disclosed herein. A UE 202 receives signals from four TRPs 204. Each TRP includes an antenna panel 206 that has eight ports (i.e., antenna elements), wherein four of the ports are V-pol and four of the ports are H-pol. For example, a cross-polarized antenna may include a V-pol port 208 and an H-pol port 210. Thus, the four TRPs 204 use a combined total of 32 ports. In certain embodiments, for multi-TRP CJT CSI reporting, the UE 202 may use a codebook structure that is given by

$$W = [ \begin{matrix}{c}^{1} \cdot {W}^{1} \\ … \\ {c}^{T} \cdot {W}^{T}\end{matrix} ] or W = {\sum }_{t = 1}^{T} {c}^{t} \cdot {W}^{t} ,$$

in which t is a TRP index corresponding to a particular TRP, T is a total number of TRPs, W¹, . . . , W^{t} are Type II CSI codebooks reported for TRPs corresponding to index t

$$( i . e . , {W}^{t} = {W}_{1}^{t} \cdot {W}_{2}^{t} \cdot {W}_{f}^{t} ) ,$$

and c₁, . . . , c^{t} are linear combination coefficients applied to each codebook for different TRPs.

Certain wireless systems support advanced CSI reporting by exploiting channel correlations. For example, in 3GPP Rel-15. Type I and Type II codebooks exploit the channel spatial domain properties. In 3GPP Rel-16, enhanced Type II codebook is supported that exploits both the channel spatial domain properties and the channel frequency domain properties. In 3GPP Rel-17, further enhanced Type II port selection (PS) codebook is supported exploiting both the channel spatial domain properties and the channel frequency domain properties.

Further, channel DL and UL correlation is exploited for reciprocity based MIMO. For UL operation, certain NR systems support non-codebook based physical uplink shared channel (PUSCH) operation. For DL operation, certain NR systems support CSI reference signal (RS) resource indicator (CRI) channel quality indicator (CQI), or cri-RI-CQI, reporting and Type II port selection codebook.

However, NR systems have not adequately exploited the channel time domain correlation for CSI reporting. A wireless channel is typically time varying and has a certain coherence time depending on, e.g., the UE movement speed and the environment change rate.

Thus, it is useful to consider CSI reporting enhancement by exploiting channel time domain properties. For example, CSI reporting enhancement may be provided for high or medium UE velocities by exploiting time domain correlation and/or Doppler domain information to assist DL precoding, targeting FRI, by 3GPP Rel-16/17 Type II codebook refinement without modification to the spatial and frequency domain basis and/or UE reporting of time-domain channel properties measured via CSI-RS for tracking.

To enhance CSI exploiting channel time domain properties, either additional time domain or Doppler domain basis can be introduced, with a new codebook structure. For example, the new codebook structure may be

$$( {W}_{f}^{*} ⊗ {W}_{1} ) {W}_{2} {W}_{t}^{H}$$

in which Wₜ is the new time domain basis. Alternatively, the new codebook structure may be W₁W₂ (Wⱼ⊕W_{d})^{H} in which W_{d} is the new Doppler domain basis selection.

Embodiments disclosed herein provide codebook design for CSI enhancement exploiting channel time domain properties. Certain embodiments provide time and/or Doppler domain basis without oversampling. Certain embodiments provide time and/or Doppler domain basis with oversampling. Certain embodiments provide combination coefficient matrix W₂ enhancement.

Time/Doppler Domain Basis without Oversampling

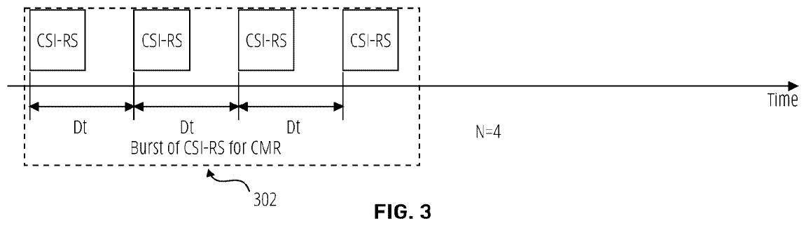

In certain embodiments, a discrete Fourier transform (DFT) sequence is used for the time domain and/or Doppler domain basis. A burst of N time domain, equally spaced, channel measurement resources (CMRs) may be used for the CSI enhancement exploiting channel time domain properties. For example, FIG. 3 illustrates a burst of CSI-RS for CMR 302, equally spaced by Dt in the time domain, where N=4. There are a total of N orthogonal DFT sequences. Each DFT sequence includes N entries. The i^{th} DFT sequence is given by

$${F}_{i} ( k ) = exp ( - j * \frac{2 π}{N} * i * k ) ,$$

where i=0, 1, . . . , N−1 and where k=0, 1, . . . , N−1. In the example shown in FIG. 3, y=DFT(x)=x*F, where 4 CSI x=(x0, x1, x2, x3), such that F is 4 by 4.

In some embodiments, a UE may, based on a CMR configuration, measure CSI reference signals from one or more TRPs to obtain CSI (i.e., multiple PMI). To compress the multiple PMI, the UE applies a DFT basis in the time/Doppler domain. In one example, when the UE feeds back multiple PMI, the multiple PMIs are related to a PMI prediction. In this example, multiple time domain equally spaced PMIs in the future are compared to CSI-RS transmissions.

In certain embodiments, when N orthogonal bases are used for time and/or Doppler domain in CSI enhancement, the network can configure the UE to select a subset T≤N bases for the CSI overhead compression. In one such embodiment, the network may configure the exact amount of orthogonal time and/or Doppler domain bases (i.e., T) that the UE will select, and T is not reported in the CSI. In another embodiment, the network may configure the maximum amount of orthogonal time and/or Doppler domain bases that UE can select (Tₘₐₓ), and the UE selects less than or the same amount of orthogonal time and/or Doppler domain bases T≤Tₘₐₓ, in which case T is reported in either CSI part 1 or CSI part 2 group 0.

In certain embodiments, when N orthogonal bases are used for time and/or Doppler domain in CSI enhancement, the network may configure the UE to select a subset T≤N bases for the CSI overhead compression. In one such embodiment, the network configures T/Tₘₐₓ as a percentage of the total N orthogonal bases. The network may configure a percentage γ, where T/Tₘₐₓ= [symbol] γN [symbol] or T/Tₘₐₓ= [symbol] γN [symbol] . In another embodiment, the network directly configures the number T/Tₘₐₓ.

In certain embodiments, when orthogonal bases are used for time and/or Doppler domain in CSI enhancement, the UE selects and reports a subset bases for the CSI overhead compression. In one such embodiment, the first orthogonal base (i.e., F₀(k)) is always selected. In another embodiment, the UE is not required to select the first orthogonal base.

In certain embodiments, when N orthogonal bases are used for time and/or Doppler domain in CSI enhancement, the UE selects and reports a subset TEN bases for the CSI overhead compression. In one such embodiment, the bases selection can be performed among all N orthogonal bases. In another embodiment, the bases selection is performed within a window of L<N consecutive orthogonal bases, with one or multiple of the following restrictions. In a first restriction, the window includes at least the first orthogonal base (i.e., F₀(k)). In a second restriction, the window starts with the first orthogonal base (i.e., F₀(k)). In a third restriction, the length of the window is proportional to the number of selected bases (e.g., the window includes min (2T, N) orthogonal bases).

Time/Doppler Domain Basis with Oversampling

In certain embodiments, an oversampled DFT sequence is used for time and/or Doppler domain basis. A burst of N time domain equally spaced CMR is used for the CSI enhancement exploiting channel time domain properties. There are a total M groups of sequences. Each group of sequences includes N orthogonal DFT sequences. Each DFT sequence includes N entries. In an m^{th} group of sequence, the i^{th} DFT sequence is given by

$${F}_{m , i} ( k ) = exp ( - j * \frac{2 π}{NM} * ( iM + m ) * k ) ,$$

where m=0, 1, . . . , M−1, where i=0, 1, . . . , N−1, and where k=0, 1, . . . , N−1.

In certain embodiments, when an oversampled DFT sequence is used for time and/or Doppler domain basis, an oversampling rate is M (i.e., M groups of orthogonal sequences are defined). The UE first reports the selected group of orthogonal sequences (i.e., the UE reports the selected m, wherein m=0, 1, . . . , M−1). Then, among the selected group of orthogonal sequences, the UE reports the subset of orthogonal sequences that is selected, as discussed above in the example embodiments for time and/or Doppler domain basis without oversampling.

In certain embodiments, when time and/or Doppler domain basis is used for CSI enhancement exploiting channel time domain properties, time and/or Doppler domain basis subset selection may be configured by the network. When oversampled time and/or Doppler domain basis is used, the NW may first group a subset of oversampled basis (i.e., the network may select \tilde{M}≤M groups of orthogonal sequences. For example, if the oversample rate is M=4 (i.e., 4 groups of orthogonal sequences are specified), the network may further select \tilde{M}=2 groups (e.g., m=0 and m=2). As a result, the UE in this example may need to evaluate m=0 and m=2 during CSI calculation.

For each selected oversampled time and/or Doppler domain basis, the network can further configure which orthogonal basis in the selected group of orthogonal bases are selected. The orthogonal basis selection can be configured with a bitmap. For example, when N=8 (i.e., 8 orthogonal sequence in the selected group of sequences), the network configures {1,0,1,0,1,0,1,0} to select 4 of the 8 orthogonal sequences for the UE to perform CSI evaluations. The selected orthogonal sequence is F₀(k), F₂(k), F₄(k), F₆(k).

### W2 Enhancement

In certain embodiments, combination coefficient matrix W₂ comprises the linear combination coefficient report in either of the following new codebook structures

$$( {W}_{f}^{*} ⊗ {W}_{1} ) {W}_{2} {W}_{t}^{H}$$

in which Wₜ is the new time domain basis, or W₁W₂(W_{f}⊗W_{d})^{H} in which W_{d} is the new Doppler domain basis selection.

In certain embodiments, for the combination coefficient matrix W₂ (i.e., linear combination coefficient report in CSI enhancement exploiting channel time domain properties), there may be different high level solutions for quantization. In one embodiment, for example, quantization of the combination coefficient matrix W₂ is performed across all the layers jointly. In another embodiment, quantization of combination coefficient matrix W₂ may be performed independently for each layer.

In certain embodiments, for reporting the non-zero coefficient (NZC) in the combination coefficient matrix W₂, the combination coefficient matrix W₂ may be divided into multiple equal-sized sub-blocks. For example, if the combination coefficient matrix W₂ is size 128 by 16, then combination coefficient matrix W₂ may be divided into 128 sub-blocks, wherein each sub-block is 16×1. As another example, the combination coefficient matrix W₂ can be divided into 32 sub-blocks, wherein each sub-block is 16×4.

Certain embodiments provide solutions for reporting the NZC in the combination coefficient matrix W₂, when the combination coefficient matrix W₂ is divided into multiple equal-sized sub-blocks. For codebook structure

$$( {W}_{f}^{*} ⊗ {W}_{1} ) {W}_{2} {W}_{t}^{H} ,$$

each sub-block may be associated with, row wise, one or multiple pairs of selected (spatial, frequency) domain basis (i.e., one or multiple consecutive columns in

$$( {W}_{f}^{*} ⊗ {W}_{1} ) ) .$$

Column wise, each sub-block may be associated with one or multiple selected time domain basis (i.e., one or multiple consecutive rows in

$${W}_{t}^{H} ) .$$

For codebook structure W₁W₂(W_{f}⊗W_{d})^{H}, each sub-block can be associated with, row wise, one or multiple selected spatial domain basis (i.e., one or multiple consecutive columns in W₁). Column wise, each sub-block may be associated with one or multiple selected pairs of (frequency, Doppler) domain basis (i.e., one or multiple consecutive rows in (Wⱼ⊗W_{d})^{H}).

In another embodiment for reporting the NZC in the combination coefficient matrix W₂, when the combination coefficient matrix W₂ is divided into multiple equal-size sub-blocks, the UE first reports a subset of sub-blocks that includes at least one NZC. For example, a bitmap can be used in which each bit corresponds to one sub-block. Then, for each reported sub-block that includes at least one NZC, the UE reports the actual location of the NZC. A bitmap can be used in which each bit corresponds to one coefficient location in the corresponding sub-block.

In another embodiment for reporting the NZC in the combination coefficient matrix W₂, when the combination coefficient matrix W₂ is divided into multiple equal-size sub-blocks, to control the CSI size, the network may configure the maximum or actual number of sub-blocks that the UE can select. Each selected sub-block comprises at least one NZC. In addition, or in other embodiments, the network may configure one of the following: for each selected sub-blocks, the maximum or actual number of NZC that can be reported: or across all the selected sub-blocks, the maximum or actual total number of NZC that can be reported.

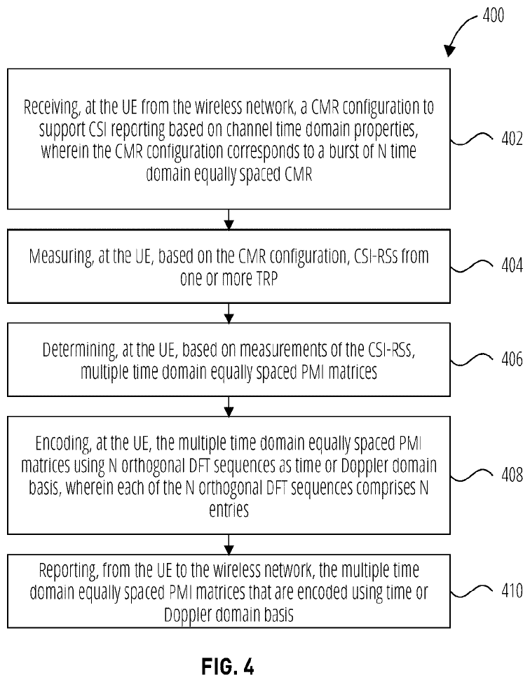

FIG. 4 illustrates a flowchart of a method 400 for a UE for communication in a wireless network, according to embodiments herein. The illustrated method 400 includes receiving 402, at the UE from the wireless network, a CMR configuration to support CSI reporting based on channel time domain properties, wherein the CMR configuration corresponds to a burst of N time domain equally spaced CMR. The method 400 further includes measuring 404, at the UE, based on the CMR configuration, CSI-RSs from one or more TRP. The method 400 further includes determining 406, at the UE, based on measurements of the CSI-RSs, multiple time domain equally spaced PMI matrices. The method 400 further includes encoding 408, at the UE, the multiple time domain equally spaced PMI matrices using N orthogonal DFT sequences as time or Doppler domain basis, wherein each of the N orthogonal DFT sequences comprises N entries. The method 400 further includes reporting 410, from the UE to the wireless network, the multiple time domain equally spaced PMI matrices that are encoded using time or Doppler domain basis.

In some embodiments of the method 400, an i^{th} DFT sequence of the N orthogonal DFT sequences is given by a function

$${F}_{i} ( k ) = exp ( - j * \frac{2 π}{N} * i * k ) ,$$

where j is an imaginary number, i=0, 1, . . . , N−1, and k=0, 1, . . . , N−1.

In some embodiments of the method 400, the UE is configured by the wireless network to select a subset T of orthogonal time or Doppler domain bases of the time or Doppler domain basis for CSI overhead compression, where T≤N. In some such embodiments, the UE is configured by the wireless network to select only the subset T of the orthogonal time or Doppler domain bases, and the UE does not report a size of the subset T in the CSI report information. In some embodiments, the UE is configured by the wireless network with a number Tₘₐₓ as a percentage of a total N orthogonal time or Doppler domain bases, where Tₘₐₓ is a maximum amount of the orthogonal time or Doppler domain bases that the UE can select. In some embodiments, the UE is configured to select a first orthogonal basis, F₀(k), from a total N orthogonal time or Doppler domain bases. In some embodiments, the UE is configured to perform bases selection among all N of the orthogonal time or Doppler domain bases.

In some embodiments, the method 400 further includes performing quantization of a combination coefficient matrix independently for each layer.

In some embodiments of the method 400, for reporting a NZC in a combination coefficient matrix, the method further includes dividing the combination coefficient matrix into multiple sub-blocks. In some such embodiments, the multiple sub-blocks are of equal size. In some embodiments, the multiple time domain equally spaced PMI matrices each comprise a codebook structure given by W₁W₂(W_{f}□W_{d})^{H}, where W₁ is a spatial basis selection matrix, W₂ is the combination coefficient matrix, W_{f} is a frequency basis selection matrix, W_{d} is a time or Doppler domain basis selection matrix, □ represents a mathematical operation corresponding to a tensor product or Kronecker product, and H denotes a Hermitian matrix or conjugate transpose operation, wherein each of the multiple sub-blocks are associated with: row wise, one or multiple columns in the spatial basis selection matrix W₁ and column wise, one or multiple selected rows in (W_{f}□W_{d})^{H}.

Embodiments contemplated herein include an apparatus comprising means to perform one or more elements of the method 400. This apparatus may be, for example, an apparatus of a UE (such as a wireless device 702 that is a UE, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a UE (such as a memory 706 of a wireless device 702 that is a UE, as described herein).

Embodiments contemplated herein include an apparatus comprising logic, modules, or circuitry to perform one or more elements of the method 400. This apparatus may be, for example, an apparatus of a UE (such as a wireless device 702 that is a UE, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a UE (such as a wireless device 702 that is a UE, as described herein).

Embodiments contemplated herein include a signal as described in or related to one or more elements of the method 400.

Embodiments contemplated herein include a computer program or computer program product comprising instructions, wherein execution of the program by a processor is to cause the processor to carry out one or more elements of the method 400. The processor may be a processor of a UE (such as a processor(s) 704 of a wireless device 702 that is a UE, as described herein). These instructions may be, for example, located in the processor and/or on a memory of the UE (such as a memory 706 of a wireless device 702 that is a UE, as described herein).

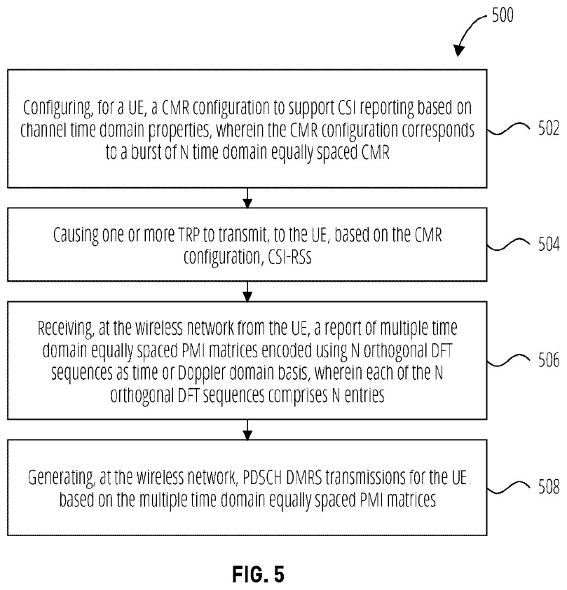

FIG. 5 illustrates a flowchart of a method 500 for a wireless network, according to embodiments herein. The illustrated method 500 includes configuring 502, for a UE, CMR configuration to support CSI reporting based on channel time domain properties, wherein the CMR configuration corresponds to a burst of N time domain equally spaced CMR. The method 500 further includes causing 504 one or more TRP to transmit, to the UE, based on the CMR configuration, CSI-RSs. The method 500 further includes receiving 506, at the wireless network from the UE, a report of multiple time domain equally spaced PMI matrices encoded using N orthogonal DFT sequences as time or Doppler domain basis, wherein each of the N orthogonal DFT sequences comprises N entries. The method 500 further includes generating 508, at the wireless network, PDSCH DMRS transmissions for the UE based on the multiple time domain equally spaced PMI matrices.

In some embodiments of the method 500, an i^{th} DFT sequence of the N orthogonal DFT sequences is given by a function

$${F}_{i} ( k ) = exp ( - j * \frac{2 π}{N} * i * k ) ,$$

where j is an imaginary number, i=0, 1, . . . , N−1, and k=0, 1 . . . , N−1.

In some embodiments of the method 500, the wireless network configures the UE to select a subset T of orthogonal time or Doppler domain bases of the time or Doppler domain basis for CSI overhead compression, where T≤N. In some such embodiments, the wireless network configures the UE to select only the subset T of the orthogonal time or Doppler domain bases, and the report does not include a size of the subset T in the CSI report information. In some embodiments, the wireless network configures the UE with a number Tₘₐₓ as a percentage of a total N orthogonal time or Doppler domain bases, where Tₘₐₓ is a maximum amount of the orthogonal time or Doppler domain bases that the UE can select. In some embodiments, the wireless network configures the UE to select a first orthogonal basis, F₀(k), from a total N orthogonal time or Doppler domain bases. In some embodiments, the wireless network configures the UE to perform bases selection among all N of the orthogonal time or Doppler domain bases.

In some embodiments of the method 500, a combination coefficient matrix is quantized independently for each layer.

In some embodiments of the method 500, for a NZC in a combination coefficient matrix in the report, the method further includes recombining the combination coefficient matrix from multiple sub-blocks. In some such embodiments, the multiple sub-blocks are of equal size. In some embodiments, the multiple time domain equally spaced PMI matrices each comprise a codebook structure given by W₁W₂(W_{f}□W_{d})^{H}, where W₁ is a spatial basis selection matrix, W₂ is the combination coefficient matrix, W_{f} is a frequency basis selection matrix, W_{d} is a time or Doppler domain basis selection matrix, □ represents a mathematical operation corresponding to a tensor product or Kronecker product, and H denotes a Hermitian matrix or conjugate transpose operation, wherein each of the multiple sub-blocks are associated with: row wise, one or multiple columns in the spatial basis selection matrix W₁ and column wise, one or multiple selected rows in (W_{f}□W_{d})^{H}.

Embodiments contemplated herein include an apparatus comprising means to perform one or more elements of the method 500. This apparatus may be, for example, an apparatus of a base station (such as a network device 718 that is a base station, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a base station (such as a memory 722 of a network device 718 that is a base station, as described herein).

Embodiments contemplated herein include an apparatus comprising logic, modules, or circuitry to perform one or more elements of the method 500. This apparatus may be, for example, an apparatus of a base station (such as a network device 718 that is a base station, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a base station (such as a network device 718 that is a base station, as described herein).

Embodiments contemplated herein include a signal as described in or related to one or more elements of the method 500.

Embodiments contemplated herein include a computer program or computer program product comprising instructions, wherein execution of the program by a processing element is to cause the processing element to carry out one or more elements of the method 500. The processor may be a processor of a base station (such as a processor(s) 720 of a network device 718 that is a base station, as described herein). These instructions may be, for example, located in the processor and/or on a memory of the base station (such as a memory 722 of a network device 718 that is a base station, as described herein).

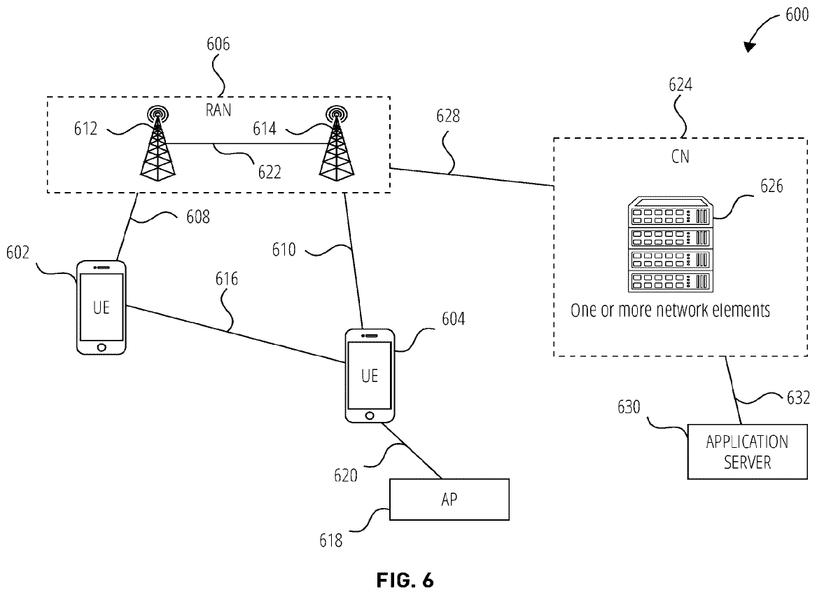

FIG. 6 illustrates an example architecture of a wireless communication system 600, according to embodiments disclosed herein. The following description is provided for an example wireless communication system 600 that operates in conjunction with the LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations, such as base station 612 and base station 614, that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VOIP sessions, group communication sessions, etc.) for the UE 602 and UE 604 via the CN 624. The application server 630 may communicate with the CN 624 through an IP communications interface 632.

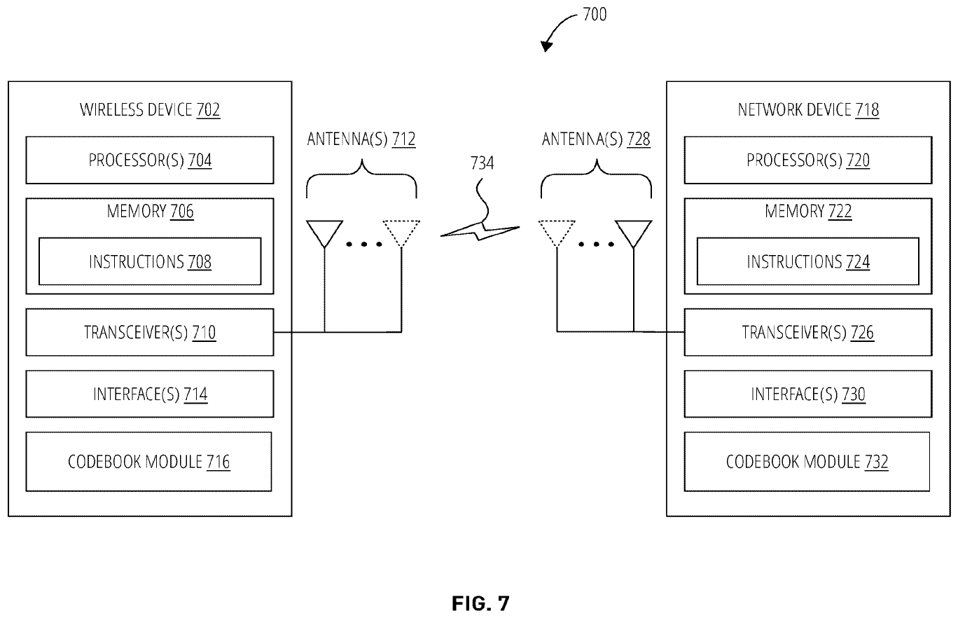

FIG. 7 illustrates a system 700 for performing signaling 734 between a wireless device 702 and a network device 718, according to embodiments disclosed herein. The system 700 may be a portion of a wireless communications system as herein described. The wireless device 702 may be, for example, a UE of a wireless communication system. The network device 718 may be, for example, a base station (e.g., an eNB or a gNB) or TRP of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 734) to and/or from the wireless device 702 with other devices (e.g., the network device 718) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include a codebook module 716. The codebook module 716 may be implemented via hardware, software, or combinations thereof. For example, the codebook module 716 may be implemented as a processor, circuit, and/or instructions 708 stored in the memory 706 and executed by the processor(s) 704. In some examples, the codebook module 716 may be integrated within the processor(s) 704 and/or the transceiver(s) 710. For example, the codebook module 716 may be implemented by a combination of software components (e.g., executed by a DSP or a general processor) and hardware components (e.g., logic gates and circuitry) within the processor(s) 704 or the transceiver(s) 710.

The codebook module 716 may be used for various aspects of the present disclosure. For example, the codebook module 716 may be configured to perform UE-based methods disclosed herein.

The network device 718 may include one or more processor(s) 720. The processor(s) 720 may execute instructions such that various operations of the network device 718 are performed, as described herein. The processor(s) 704 may include one or more baseband processors implemented using, for example, a CPU, a DSP, an ASIC, a controller, an FPGA device, another hardware device, a firmware device, or any combination thereof configured to perform the operations described herein.

The network device 718 may include a memory 722. The memory 722 may be a non-transitory computer-readable storage medium that stores instructions 724 (which may include, for example, the instructions being executed by the processor(s) 720). The instructions 724 may also be referred to as program code or a computer program. The memory 722 may also store data used by, and results computed by, the processor(s) 720.

The network device 718 may include one or more transceiver(s) 726 that may include RF transmitter and/or receiver circuitry that use the antenna(s) 728 of the network device 718 to facilitate signaling (e.g., the signaling 734) to and/or from the network device 718 with other devices (e.g., the wireless device 702) according to corresponding RATs.

The network device 718 may include one or more antenna(s) 728 (e.g., one, two, four, or more). In embodiments having multiple antenna(s) 728, the network device 718 may perform MIMO, digital beamforming, analog beamforming, beam steering, etc., as has been described.

The network device 718 may include one or more interface(s) 730. The interface(s) 730 may be used to provide input to or output from the network device 718. For example, a network device 718 that is a base station may include interface(s) 730 made up of transmitters, receivers, and other circuitry (e.g., other than the transceiver(s) 726/antenna(s) 728 already described) that enables the base station to communicate with other equipment in a core network, and/or that enables the base station to communicate with external networks, computers, databases, and the like for purposes of operations, administration, and maintenance of the base station or other equipment operably connected thereto.

The network device 718 may include a codebook module 732. The codebook module 732 may be implemented via hardware, software, or combinations thereof. For example, the codebook module 732 may be implemented as a processor, circuit, and/or instructions 724 stored in the memory 722 and executed by the processor(s) 720. In some examples, the codebook module 732 may be integrated within the processor(s) 720 and/or the transceiver(s) 726. For example, the codebook module 732 may be implemented by a combination of software components (e.g., executed by a DSP or a general processor) and hardware components (e.g., logic gates and circuitry) within the processor(s) 720 or the transceiver(s) 726.

The codebook module 732 may be used for various aspects of the present disclosure. For example, the codebook module 732 may be configured to perform network-based methods as disclosed herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) for communication in a wireless network, the method comprising:
receiving, at the UE from the wireless network, a channel measurement resource (CMR) configuration to support channel state information (CSI) reporting based on channel time domain properties, wherein the CMR configuration corresponds to a burst of N time domain equally spaced CMR;
measuring, at the UE, based on the CMR configuration, CSI references signals (CSI-RSs) from one or more transmission and reception point (TRP);
determining, at the UE, based on measurements of the CSI-RSs, multiple time domain equally spaced precoding matrix indicator (PMI) matrices;
encoding, at the UE, the multiple time domain equally spaced PMI matrices using N orthogonal discrete Fourier transform (DFT) sequences as time or Doppler domain basis, wherein each of the N orthogonal DFT sequences comprises N entries; and
reporting, from the UE to the wireless network, the multiple time domain equally spaced PMI matrices that are encoded using time or Doppler domain basis.

2. The method of claim 1, wherein an i^{th} DFT sequence of the N orthogonal DFT sequences is given by a function
$${F}_{i} ( k ) = exp ( - j * \frac{2 π}{N} * i * k ) ,$$
where j is an imaginary number, i=0, 1, . . . , N−1, and k=0, 1, . . . , N−1.

3. The method of claim 1, wherein the UE is configured by the wireless network to select a subset T of orthogonal time or Doppler domain bases of the time or Doppler domain basis for CSI overhead compression, where T≤N.

4. The method of claim 3, wherein the UE is configured by the wireless network to select only the subset T of the orthogonal time or Doppler domain bases, and wherein the UE does not report a size of the subset T in the CSI report information.

5. The method of claim 3, wherein the UE is configured by the wireless network with a number Tₘₐₓ as a percentage of a total N orthogonal time or Doppler domain bases, where Tₘₐₓ is a maximum amount of the orthogonal time or Doppler domain bases that the UE can select.

6. The method of claim 3, wherein the UE is configured to select a first orthogonal basis, F₀(k), from a total N orthogonal time or Doppler domain bases.

7. The method of claim 3, wherein the UE is configured to perform bases selection among all N of the orthogonal time or Doppler domain bases.

8. The method of claim 1, further comprising performing quantization of a combination coefficient matrix independently for each layer.

9. The method of claim 1, wherein for reporting a non-zero coefficient (NZC) in a combination coefficient matrix, the method further comprises dividing the combination coefficient matrix into multiple sub-blocks.

10. The method of claim 9, wherein the multiple sub-blocks are of equal size.

11. The method of claim 9, wherein the multiple time domain equally spaced PMI matrices each comprise a codebook structure given by W₁W₂(W_{f}⊗W_{d})^{H}, where W₁ is a spatial basis selection matrix, W₂ is the combination coefficient matrix, W_{f} is a frequency basis selection matrix, W_{d} is a time or Doppler domain basis selection matrix, ⊗ represents a mathematical operation corresponding to a tensor product or Kronecker product, and H denotes a Hermitian matrix or conjugate transpose operation,
wherein each of the multiple sub-blocks are associated with:
row wise, one or multiple columns in the spatial basis selection matrix W₁; and
column wise, one or multiple selected rows in (W_{f}⊗W_{d})^{H}.

12. A method for a wireless network, the method comprising:
configuring, for a user equipment (UE), a channel measurement resource (CMR) configuration to support channel state information (CSI) reporting based on channel time domain properties, wherein the CMR configuration corresponds to a burst of N time domain equally spaced CMR;
causing one or more transmission and reception point (TRP) to transmit, to the UE, based on the CMR configuration, CSI references signals (CSI-RSs);
receiving, at the wireless network from the UE, a report of multiple time domain equally spaced precoding matrix indicator (PMI) matrices encoded using N orthogonal discrete Fourier transform (DFT) sequences as time or Doppler domain basis, wherein each of the N orthogonal DFT sequences comprises N entries; and
generating, at the wireless network, physical downlink shared channel (PDSCH) demodulation reference signal (DMRS) transmissions for the UE based on the multiple time domain equally spaced PMI matrices.

13. The method of claim 12, wherein an i^{th} DFT sequence of the N orthogonal DFT sequences is given by a function
$${F}_{i} ( k ) = exp ( - j * \frac{2 π}{N} * i * k ) ,$$
where j is an imaginary number, i=0, 1, . . . , N−1, and k=0, 1, . . . , N−1.

14. The method of claim 12, wherein the wireless network configures the UE to select a subset T of orthogonal time or Doppler domain bases of the time or Doppler domain basis for CSI overhead compression, where T≤N.

15. The method of claim 14, wherein the wireless network configures the UE to select only the subset T of the orthogonal time or Doppler domain bases, and wherein the report does not include a size of the subset T in the CSI report information.

16. The method of claim 14, wherein the wireless network configures the UE with a number Tₘₐₓ as a percentage of a total N orthogonal time or Doppler domain bases, where Tₘₐₓ is a maximum amount of the orthogonal time or Doppler domain bases that the UE can select.

17. The method of claim 14, wherein the wireless network configures the UE to select a first orthogonal basis, F₀(k), from a total N orthogonal time or Doppler domain bases.

18. The method of claim 14, wherein the wireless network configures the UE to perform bases selection among all N of the orthogonal time or Doppler domain bases.

19. The method of claim 12, wherein a combination coefficient matrix is quantized independently for each layer.

20. The method of claim 12, wherein for a non-zero coefficient (NZC) in a combination coefficient matrix in the report, the method further comprises recombining the combination coefficient matrix from multiple sub-blocks.

21-25. (canceled)
